(19) United States
(12) Patent Application Publication
(10) Pub. No.: US 2009/0182693 A1
(43) Pub. Date: Jul. 16, 2009

(54) Determining stimulation design parameters using artificial neural networks optimized with a genetic algorithm

(75) Inventors: Dwight David Fulton, Duncan, OK (US); Stanley V. Stephenson, Duncan, OK (US)

Correspondence Address: ROBERT A. KENT, P.O. BOX 1431, DUNCAN, OK, 73536, US

(73) Assignee: Halliburton Energy Services, Inc.

(21) Appl. No.: 11/986,763

(22) Filed: Jan. 14, 2008

(51) Int. Cl. G06N 3/08

(52) U.S. Cl. 706/16

(57) ABSTRACT

A method for generating an artificial neural network ensemble for determining stimulation design parameters. A population of artificial neural networks is trained to produce one or more output values in response to a plurality of input values. The population of artificial neural networks is optimized to create an optimized population of artificial neural networks. A plurality of ensembles of artificial neural networks is selected from the optimized population of artificial neural networks and optimized using a genetic algorithm having a multi-objective fitness function. The ensemble with the desired prediction accuracy based on the multi-objective fitness function is then selected.

### BACKGROUND

This invention relates to neural networks trained to predict one or more parameters in response to a plurality of inputs, and more particularly to methods for using multiple multi-objective optimization processes to select neural network ensembles for determining synthetic open hole log parameters, which may be used to determine stimulation design parameters.

In the oil and gas industry, common procedures are performed in order to increase the production potential from wells. Among other types of treatments, stimulation treatments are intended to increase the oil and gas production from existing production zones within a well. Common examples of stimulation treatments include hydraulic fracturing and acid treatments. In order to maximize the treatment's effectiveness and avoid damage to the hydrocarbon bearing formation, certain formation properties are used to calculate the treatments that should be used and how they should be performed.

These reservoir properties are typically determined from well logs run in either the open hole after drilling or the casing lined well. Open hole logs may provide the best source of useful information for determining stimulation treatments in at least some cases. Several types of open hole logs may be used to measure the properties required for an effective design of a stimulation treatment. For example, a “triple combo” log measures bulk density, neutron porosity, and formation resistivity. This information may be used with mathematical correlations to derive values used in stimulation design including: reservoir effective porosity, water saturation, and effective permeability. Additional mathematical equations may be applied to triple combo log data to estimate rock mechanical properties, such as Young's modulus, Poisson's ratio, and in-situ stress. These parameters, especially permeability and the rock mechanical properties, play a crucial role in the design of a stimulation treatment.

While triple combo logs are readily available, the variability of the calculated reservoir and rock parameters based on these logs is typically quite large. This variability is reduced only if the mathematical equations are fine-tuned or calibrated by matching the calculated values to those determined from other independent sources, such as core tests or well tests. Such rigorous matching is infrequent and thus the accuracy of common treatment designs is limited by the variability.

Nuclear magnetic resonance, or NMR, logging technology can provide far greater accuracy in the base determination of fluid saturations and porosity distributions, leading to more accurately calculated parameters and more accurate stimulation designs. Implementation of NMR logging may be referred to as magnetic resonance induction logging, or MRIL, technology. However, MRIL logs are run much less frequently than triple combo logs, and thus the MRIL log data is usually sparsely available. In addition, acoustic logging tools may be used to determine the acoustic compressional and shear velocities of the reservoir rock. These measurements are thought to lead to more accurate estimates of rock mechanical properties than those from triple combo log data, and greater accuracy of fracture treatment designs. However, acoustic logs represent additional logs that must be run during completion operations, increasing the cost and time involved in the drilling and completion of a hydrocarbon producing well.

### SUMMARY

This invention relates to neural networks trained to predict one or more parameters in response to a plurality of inputs, and more particularly to methods for using multiple multi-objective optimization processes to select neural network ensembles for determining synthetic open hole log parameters, which may be used to determine stimulation design parameters.

In one embodiment, the present invention provides methods for generating an artificial neural network ensemble comprising: training a population of artificial neural networks to produce one or more output values in response to a plurality of input values; optimizing the population of artificial neural networks to create an optimized population of artificial neural networks; selecting a plurality of ensembles of artificial neural networks selected from the optimized population of artificial neural networks; optimizing the plurality of ensembles of artificial neural networks using a genetic algorithm having a multi-objective fitness function; and selecting an ensemble with the desired prediction accuracy based on the multi-objective fitness function.

In another embodiment, the present invention provides a computer program, stored in a tangible medium, for producing a synthetic open hole log in response to an actual open hole log parameter, comprising an artificial neural network ensemble, the program comprising executable instruction that cause a computer to: train a population of artificial neural networks to produce one or more synthetic open hole log parameters in response to a plurality of measured open hole log parameters; optimize the population of artificial neural networks to create an optimized population of artificial neural networks; select a plurality of ensembles of artificial neural networks selected from the optimized population of artificial neural networks; optimize the plurality of ensembles of artificial neural networks using a genetic algorithm having a multi-objective fitness function; and select an ensemble with the desired prediction accuracy based on the multi-objective fitness function.

In another embodiment, the present invention provides a method for creating an artificial neural network ensemble for generating a synthetic MRIL and acoustic log parameter comprising: training a population of artificial neural networks to produce one or more synthetic NMR and acoustic log parameters in response to a plurality of measured open hole log parameters; optimizing the population of artificial neural networks to create an optimized population of artificial neural networks using a genetic algorithm having a multi-objective fitness function; selecting a plurality of ensembles of artificial neural networks selected from the optimized population of artificial neural networks; optimizing the plurality of ensembles of artificial neural networks using a genetic algorithm having a multi-objective fitness function; selecting an ensemble with the desired prediction accuracy based on the multi-objective fitness function.

The features and advantages of the present invention will be readily apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 is a flow chart illustrating an overall operation of an embodiment of the present invention.

FIG. 2 is a flow chart illustrating the details of an embodiment involving training an artificial neural network.

### DESCRIPTION OF PREFERRED EMBODIMENTS

This invention relates to neural networks trained to predict one or more parameters in response to a plurality of inputs, and more particularly to methods for using multiple multi-objective optimization processes to select neural network ensembles for determining synthetic open hole log parameters, which may be used to determine stimulation design parameters.

The present disclosure describes a method for generating artificial open hole MRIL and acoustic log parameters based on input obtained from actual open hole logs such as a triple combo log. More specifically, the present invention utilizes an optimized population of artificial neural networks (“ANNs”) to create ensembles of ANNs that can be used to produce stimulation design parameters.

The ability to quickly and inexpensively analyze well logging data is gaining increasing significance. Companies providing goods and services for use in developing oil or gas reservoirs potentially base major business decisions on reservoir analysis. It is believed that the present invention can provide field engineers with a distinct process for obtaining stimulation design parameters, thus providing customers with a relatively enhanced stimulation design based on commonly-available well logging data.

Acronyms:

ANN: artificial neural networks

Cal: caliber

SP: spontaneous potential

MBVI: bulk volume irreducible

MPERM: permeability

MPHI: effective porosity

MSWE: effective water saturation

MSWI: irreducible water saturation

PE: photoelectric constant

An embodiment of the present invention utilizes data from a small number of wells in an area or hydrocarbon producing field of interest in which triple combo logs, MRIL logs, acoustic logs, or a combination of MRIL logs and acoustic logs have been run. In this embodiment, the logging data and parameters are used to train a population of ANNs to provide a synthetic MRIL or acoustic log. A genetic algorithm, as would be known to one skilled in the arts, is used to define the neural topology and inputs that will provide the most accurate ANN. The population of ANNs is optimized using a genetic algorithm to select the combination of ANNs that will give the greatest accuracy in predicting synthetic MRIL or acoustic logs. In an embodiment, the genetic algorithm is used to evaluate the overall set of ANNs generated from the optimized population of ANNs and selects an ensemble of ANNs that provide the highest potential for reproducing the desired outputs. The resulting ANN systems and ensemble can be used to generate synthetic MRIL and acoustic logs from triple combo log data for use in future treatment designs generated in the area for which the system was developed.

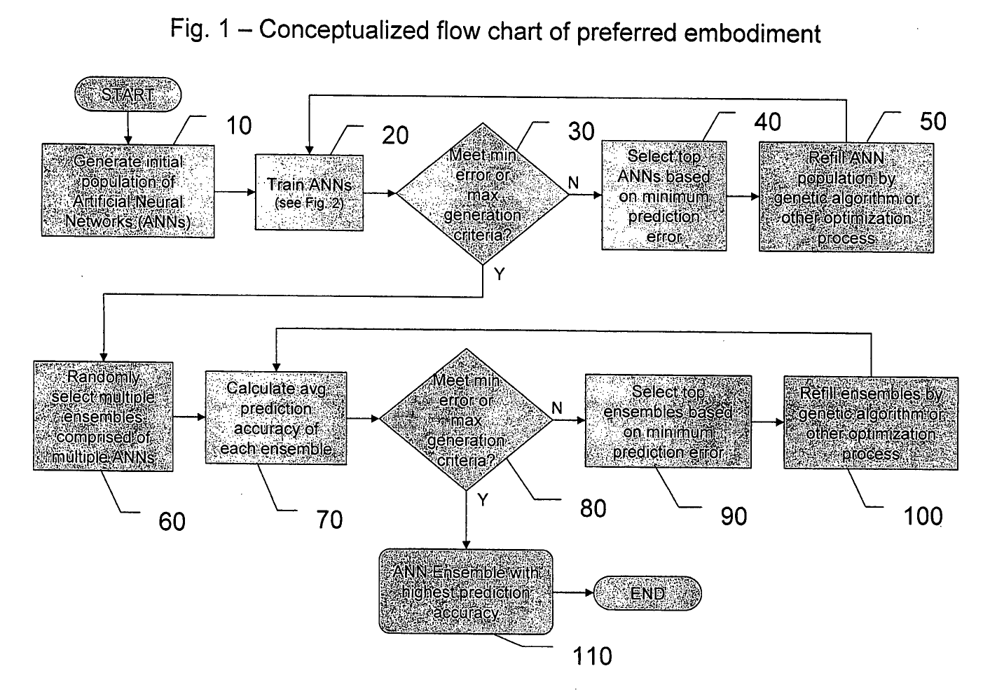

FIG. 1 illustrates the overall structure of an embodiment of the disclosed invention. Block 10 represents the creation of a population of ANNs. In an embodiment, the population of ANNs are created using a computer. The computer may be of any type capable of performing artificial neural network and genetic algorithm operations of the present invention. Examples of a suitable computer include, but are not limited to, a computer having a processor, a memory, and storage. The methods may be represented as instructions stored in software run on the computer. Additionally, the method may be stored in ROM on the computer. The computer may be operated with any suitable operating system capable of running application programs. Examples of suitable operating systems include, without limitation, Windows 3.1, Windows 95, and Windows NT, Windows 2000, Windows XP and Windows Vista. Software is also available to run on UNIX, DOS, OS2/2.1 and Macintosh System 7.x or higher operating systems.

In an embodiment, the population of ANNs may be created on the computer using a neural and genetic application program. The neural section allows training of the topologies selected by the genetic portion of the program. The neural and genetic program may be of any suitable type. Specific examples include, without limitation, NeuroGenetic Optimizer (“NGO”) by BioComp Systems, Inc., Neuralyst by Cheshire Engineering Corporation, Brain-Maker Genetic Training Option by California Scientific Software, MATLAB by The MathWorks, Inc. Similar results could be obtained using separate neural network software and genetic algorithm software and then linking them together. An example of these separate software programs is NeuroShell 2 neural net software and GeneHunter genetic algorithm software by Ward Systems Group, Inc.

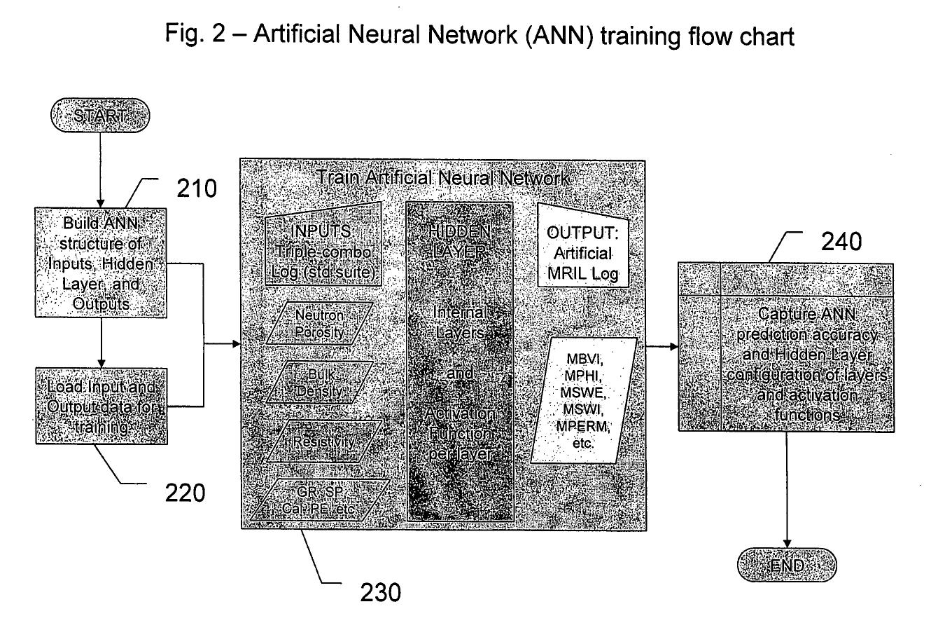

Once the population of ANNs is generated, they are trained 20 based on existing data, as further detailed in FIG. 2. In an embodiment of the present invention the population of ANNs may be trained by first building the ANN structure comprising inputs, hidden layers, and outputs 210. In this embodiment, the data is first organized in a comma delimited format (*.csv) with the outputs in the far right columns. Next, the number of outputs to be matched are selected. The neural parameters to be used for each ANN are then selected. A limit on the number of neurons in a hidden layer places boundaries on the search region of a genetic algorithm. Hidden layers may be limited to one or two. The smaller number narrows the search region of the genetic algorithm. The types of transfer functions can also be set for the hidden layers and may consist of hyperbolic tangent, logistic, or linear functions. In an embodiment, these three types of transfer functions will automatically be used for the search region for the output layer if the system is not limited to linear outputs. Linear output may be selected in order to allow for a better prediction of data points beyond the original training data space. In certain embodiments, diversity of neural parameters may be desirable as a broader range of solutions may be obtained. In these instances, different architectures, for example a different number of hidden nodes or transfer functions, may be used in each individual ANN and they may be referred to as heterogeneous ANNs. As used herein, heterogeneous means that the structure of at least two ANNs within the population vary, even if individual members within the population have identical structures.

The input data and output data for training may then be loaded 220. Once the input and output data are loaded, the artificial neural network system separates the data into a train and a test data group. In an embodiment, the default for this selection places 50% of the data in the train data group and 50% in the test data group. These groups are selected such that the means of the train and test data groups are within a user specified number of standard deviations of the complete data set. This automation may result in a more efficient selection process relative to manual selection of data set that meet statistical qualifications.

In an embodiment, the input data may comprise any number of well parameters useful in producing an artificial MRIL log, an artificial acoustic log, or a combination of the two. Examples of formation parameters that may be useful with the present invention include, without limitation: porosity, permeability, formation resistivity, bulk density, gamma ray, SP, Cal, and PE. The output data may include the parameters measured by an MRIL log or the hidden layer configuration and activation functions and passes them on to the comparison operator at step 30.

Returning to FIG. 1, the next step involves the comparison of the prediction accuracies recorded during training with the multi-objective fitness criteria 30. In an embodiment, the multi-objective fitness function criteria may comprise an average absolute error criteria, a minimum absolute error criteria, a minimum prediction error criteria, or a maximum error generation criteria. If the ANNs do not meet the minimum prediction error criteria or the maximum error generation limits in the embodiment, then the ANNs enter the optimization process. The optimization process may comprise any optimization process known to one skilled in the arts capable of generating a population of ANNs that will meet the minimum prediction error criteria or the maximum error generation limits. In an embodiment, a genetic algorithm is used to optimize the population of ANNs. In the NGO program, “Optimizing” neural training mode is selected to activate the genetic algorithms. The genetic parameters are then set in order to run the optimization. The population size is set between thirty and forty and a selection mode is set such that approximately fifty percent of the population yielding a neural topology and selected input parameters having the greatest impact with that topology will survive to be used as the breeding stock for the next generation. The surviving topologies represent those ANNs from the population of ANNs with the minimum prediction error 40. The mating technique selected is a tail swap with the remaining population refilled by cloning 50. A mutation rate, such as 0.25 in an embodiment, is used and allows for diversity in the reproduced ANNs in order to avoid local minima. The refilled population of ANNs is then sent back to training step 20.

Next, the system parameters are set including the choice of the multi-objective fitness function. In an embodiment, the “average absolute accuracy” is selected as the multi-objective fitness function for determining the accuracy of each ANN examined by the NGO algorithms. In an alternative embodiment, the minimum absolute error may be used to determine the accuracy of each ANN. The system is set to stop optimizing when either fifty generations have passed in the genetic algorithm or when an “average absolute error” of 0.0 is reached for one out of the population of ANNs.

The optimization system comprising the initially trained population of ANNs is then run. While running, the optimization system will train on the training data set and test the error on the test data set. This will determine the validity of each topology tested since the system will not see the test data set during training, but instead the system will only see the test data after the topology is trained with the training data. As the system continues to run, the topologies with the best accuracies are saved for further analysis. When the system has reached the fiftieth generation or the population convergence factor stops improving, the best topologies are examined. In an embodiment, approximately forty to fifty topologies may be retained as the best topologies during the course of optimization. These best topologies are again run, but with the number of maximum passes increased to allow the topologies to be trained to their maximum potentials. In an embodiment, the number of maximum passes may be increased to three hundred.

Once the population of ANNs has satisfied the multi-objective fitness function, the population is passed to the ensemble selection step 60. In this step, multiple ensembles comprising multiple ANNs chosen from the optimized population of ANNs are randomly selected. In an embodiment, ensembles may be chosen with optimized ANNs in each ensemble. In a preferred embodiment, an ANN ensemble would contain any number of optimized ANNs.

The randomly selected ANN ensembles are next passed to step 70 wherein the ensembles are evaluated by a multi-objective fitness function to determine how closely the ensembles perform the desired function. In an embodiment, the multi-objective fitness function criteria may focus on the average prediction accuracy, the average absolute error, or the minimum absolute error. In addition, the measurement criteria may be different or the same as the criteria used during the optimization of the population of ANNs in step 30. In an embodiment, the multi-objective fitness function may calculate the average prediction accuracy of each ensemble and rank the ensembles according to the results. In evaluating the multi-objective fitness function, each individual ANN within the ensemble is evenly weighted. As used herein, evenly weighted refers to the fraction assigned to the evaluation result for each individual ANN within the ensemble. In an evenly weighted calculation, each individual ANN result is assigned the same fractional value as all other individual ANNs within the same ensemble. In an alternative embodiment, different weights may be assigned to individual ANNs within the ensemble based on the ANN evaluation during optimization of the population of ANNs in step 30. The results of the multi-fitness function calculation are then compared to the fitness criteria in step 80 to determine if a further optimization process is required to improve the ensemble accuracy.

If the multi-objective fitness function does not meet the established criteria, then the randomly selected ANN ensembles are passed to the ANN ensemble optimization process. The optimization process may comprise any optimization process known to one skilled in the arts capable of generating a population of ANN ensembles that will meet the multi-objective fitness function criteria. In an embodiment, a genetic algorithm is used to optimize the ANN ensembles. A conventional genetic algorithm processes the selection of ANN ensembles and selects the top ensembles based on the multi-function fitness criteria 90. In an embodiment, crossover and mutation does not occur during the ANN ensemble optimization. Rather, new ensembles are chosen based on the top ANN ensembles from the previous iteration to refill the discarded ensembles from the previous iteration. However, alternative embodiments may contain crossover and mutation functions that are performed to generate a new set of ensembles to refill the previously discarded ensembles. In either case, the new set is returned to step 70 to begin the optimization process.

The process is continued until at step 80 the multi-function fitness criteria for the ensembles is met. The set of ensembles meeting the multi-function fitness criteria is then placed into memory and becomes the optimized ANN ensembles. The optimized ANN ensembles may be ranked according to the multi-objective fitness function evaluation performed at step 80. Once the top ensembles are identified and ranked, the top optimized ANN ensemble may be chosen as the ensemble with the highest prediction accuracy. As the ensemble with the highest multi-objective fitness function score, the ensemble with the highest prediction accuracy should be the most capable of predicting output based on a given set of inputs.

Once the ANN ensemble with the highest prediction accuracy has been chosen, input parameters may be provided to the ANN ensemble in order to generate artificial output parameters. In an embodiment, open hole parameters may be provided to the ANN ensemble to produce an artificial MRIL log, an acoustic log, or both as output. In this embodiment, the population of ANNs and the ANN ensembles are trained and testing using measured open hole data. As such, the ANN ensemble with the highest prediction accuracy is useful for predicting synthetic MRIL and acoustic logs for wells located in the same oil field from which the training and test data derived. The synthetic logs may therefore be generated fitness criteria in step 80 to determine if a further optimization process is required to improve the ensemble accuracy.

If the multi-objective fitness function does not meet the established criteria, then the randomly selected ANN ensembles are passed to the ANN ensemble optimization process. The optimization process may comprise any optimization process known to one skilled in the arts capable of generating a population of ANN ensembles that will meet the multi-objective fitness function criteria. In an embodiment, a genetic algorithm is used to optimize the ANN ensembles. A conventional genetic algorithm processes the selection of ANN ensembles and selects the top ensembles based on the multi-function fitness criteria 90. In an embodiment, crossover and mutation does not occur during the ANN ensemble optimization. Rather, new ensembles are chosen based on the top ANN ensembles from the previous iteration to refill the discarded ensembles from the previous iteration. However, alternative embodiments may contain crossover and mutation functions that are performed to generate a new set of ensembles to refill the previously discarded ensembles. In either case, the new set is returned to step 70 to begin the optimization process.

The process is continued until at step 80 the multi-function fitness criteria for the ensembles is met. The set of ensembles meeting the multi-function fitness criteria is then placed into memory and becomes the optimized ANN ensembles. The optimized ANN ensembles may be ranked according to the multi-objective fitness function evaluation performed at step 80. Once the top ensembles are identified and ranked, the top optimized ANN ensemble may be chosen as the ensemble with the highest prediction accuracy. As the ensemble with the highest multi-objective fitness function score, the ensemble with the highest prediction accuracy should be the most capable of predicting output based on a given set of inputs.

Once the ANN ensemble with the highest prediction accuracy has been chosen, input parameters may be provided to the ANN ensemble in order to generate artificial output parameters. In an embodiment, open hole parameters may be provided to the ANN ensemble to produce an artificial MRIL log, an acoustic log, or both as output. In this embodiment, the population of ANNs and the ANN ensembles are trained and testing using measured open hole data. As such, the ANN ensemble with the highest prediction accuracy is useful for predicting synthetic MRIL and acoustic logs for wells located in the same oil field from which the training and test data derived. The synthetic logs may therefore be generated from wells in the same oil field that did not have any training or test data available. These artificial logs may then provide the parameters necessary for a more accurate stimulation treatment design.

In an embodiment, the optimized population of ANNs may be used as a starting point for the selection of an ANN ensemble with the highest prediction accuracy in similar oil fields. In this embodiment, an oil field that is similar to the one from which the training and test data was derived will make use of the optimized population of ANNs previously derived. An ANN ensemble would then be optimized using data derived from the specific field in order to ensure that the ensemble was accurate for use within the specific oil field. Using this method may reduce the input and training data requirements for similar fields that may not have the quantity of data necessary to generate the optimized population of ANNs. Alternatively, use of this alternative procedure may save time and money by using an existing population of ANNs.

In an alternative embodiment, the ANN ensemble optimization process of the present invention may be combined with a stimulation treatment design process to form a single overall process for determining stimulation treatment parameters. In this embodiment, open hole parameters may be supplied to the population of ANNs in order to produce artificial MRIL log parameters, artificial acoustic log parameters, or both. The artificially generated parameters may then be used to calculate stimulation treatment or well workover parameters. In this embodiment, the optimized ANN ensemble may be used to directly calculate the stimulation treatment or well workover parameters without first calculating the artificial open hole log parameters.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Moreover, the indefinite articles “a” or “an”, as used in the claims, are defined herein to mean one or more than one of the element that it introduces. Also, the terms in the claims have their plain, ordinary meaning unless otherwise explicitly and clearly defined by the patentee.

What we claim is:

1. A method for generating an artificial neural network ensemble comprising:
training a population of artificial neural networks to produce one or more output values in response to a plurality of input values;
optimizing the population of artificial neural networks to create an optimized population of artificial neural networks;
selecting a plurality of ensembles of artificial neural networks selected from the optimized population of artificial neural networks;
optimizing the plurality of ensembles of artificial neural networks using a genetic algorithm having a multi-objective fitness function;
selecting an ensemble with the desired prediction accuracy based on the multi-objective fitness function.

2. The method of claim 1 wherein the optimization of the population of artificial neural networks is performed using a genetic algorithm having a multi-objective fitness function.

3. The method of claim 2 wherein the optimization of the plurality of ensembles of artificial neural networks comprises testing of the ensembles with actual input values and output values to calculate the multi-objective fitness function.

4. The method of claim 3 wherein the plurality of inputs used to train the population of artificial neural networks comprises an open hole log parameter.

5. The method of claim 4 wherein the ensemble with the highest prediction accuracy produces as output a synthetic log, wherein the synthetic log comprises a synthetic log parameter.

6. The method of claim 5 wherein the open hole log parameter is selected from the group consisting of a triple combo log parameter, neutron porosity, bulk density, formation resistivity, GR, SP, Cal, PE, a combination thereof, and a derivative thereof.

7. The method of claim 5 wherein the synthetic log parameter is selected from the group consisting of a NMR log parameter, a MRIL log parameter, MBVI parameter, a MPHI parameter, a MSWE parameter, a MSWI parameter, a MPERM parameter, a combination thereof, and a derivative thereof.

8. The method of claim 5 wherein a design for a stimulation treatment of a well is created in part in response to at least one synthetic log parameter.

9. The method of claim 1 wherein the plurality of ensembles of artificial neural networks comprise a plurality of optimized artificial neural networks.

10. The method of claim 1 wherein the ensemble with the desired prediction accuracy produces as output a stimulation treatment design parameter.

11. The method of claim 1 wherein the population of artificial neural networks have a heterogeneous mix of hidden layers.

12. A computer program, stored in a tangible medium, for producing a synthetic open hole log in response to an actual open hole log parameter, comprising an artificial neural network ensemble, the program comprising executable instruction that cause a computer to:
train a population of artificial neural networks to produce one or more synthetic open hole log parameters in response to a plurality of measured open hole log parameters;
optimize the population of artificial neural networks to create an optimized population of artificial neural networks;
select a plurality of ensembles of artificial neural networks selected from the optimized population of artificial neural networks;
optimize the plurality of ensembles of artificial neural networks using a genetic algorithm having a multi-objective fitness function;
select an ensemble with the desired prediction accuracy based on the multi-objective fitness function.

13. The computer program of claim 12 wherein the executable instructions cause a computer to optimize the population of artificial neural networks using a genetic algorithm having a multi-objective fitness function.

14. The computer program of claim 13 wherein the executable instructions cause a computer to select the measured open hole log parameters from the group consisting of a triple combo log parameter, neutron porosity, bulk density, formation resistivity, GR, SP, Cal, PE, a combination thereof, and a derivative thereof.

15. The computer program of claim 13 wherein the executable instructions cause a computer to select the synthetic open hole log parameter from the group consisting of a NMR log parameter, MRIL log parameter, a MBVI parameter, a MPHI parameter, a MSWE parameter, a MSWI parameter, a MPERM parameter, a combination thereof, and a derivative thereof.

16. The computer program of claim 12 wherein the executable instructions cause a computer to create a design for a stimulation treatment of a well in part in response to at least one synthetic open hole log parameter.

17. The computer program of claim 13 wherein the executable instructions cause a computer to use a different multi-objective fitness function in the optimization of the population of artificial neural networks than the multi-objective fitness function used in optimizing the plurality of ensembles of artificial neural networks.

18. A method for creating an artificial neural network ensemble for generating a synthetic MRIL and acoustic log parameter comprising:
training a population of artificial neural networks to produce one or more synthetic NMR and acoustic log parameters in response to a plurality of measured open hole log parameters;
optimizing the population of artificial neural networks to create an optimized population of artificial neural networks using a genetic algorithm having a multi-objective fitness function;
selecting a plurality of ensembles of artificial neural networks selected from the optimized population of artificial neural networks;
optimizing the plurality of ensembles of artificial neural networks using a genetic algorithm having a multi-objective fitness function;
selecting an ensemble with the desired prediction accuracy based on the multi-objective fitness function.

19. The method of claim 18 wherein the plurality of measured open hole log parameter are selected from the group consisting of a triple combo log parameter, neutron porosity, bulk density, formation resistivity, GR, SP, Cal, PE, a combination thereof, and a derivative thereof.

20. The method of claim 18 wherein the synthetic NMR and acoustic log parameter is selected from the group consisting of a MBVI parameter, a MPHI parameter, a MSWE parameter, a MSWI parameter, a MPERM parameter, a combination thereof, and a derivative thereof.

21. The method of claim 18 wherein the synthetic NMR and acoustic log parameters are used at least in part to create a design for a stimulation treatment of a well.
